(19) United States
(12) Patent Application Publication
(10) Pub. No.: US 2021/0123397 A1
(43) Pub. Date: Apr. 29, 2021

(54) ENGINE UNIT

(71) Applicant: TOYOTA JIDOSHA KABUSHIKI KAISHA, Aichi-ken (JP)

(72) Inventors: Hisayuki ITOH, Toyota-shi (JP); Koji ICHIKAWA, Aichi-gun (JP); Hirokazu KATO, Nisshin-shi (JP); Masaaki YAMAGUCHI, Okazaki-shi (JP)

(21) Appl. No.: 17/009,784

(22) Filed: Sep. 2, 2020

(30) Foreign Application Priority Data
Oct. 24, 2019 (JP) 2019-193600

(51) Int. Cl. F02M 26/50; F02M 26/49

(52) U.S. Cl. CPC F02M 26/50; F02M 26/49

(57) ABSTRACT

An engine unit includes an engine, an exhaust gas recirculation device including a communication pipe by which an exhaust pipe of the engine and an intake pipe of the engine to communicating and a valve that is provided in the communication pipe, and a control device. The control device is configured to perform a foreign matter removal control that is opening and closing the valve when catching of foreign matter in the valve is detected and the engine stops.

### INCORPORATION BY REFERENCE

The disclosure of Japanese Patent Application No. 2019-193600 filed on Oct. 24, 2019 including the specification, drawings and abstract is incorporated herein by reference in its entirety.

### BACKGROUND

### 1. Technical Field

The disclosure relates to an engine unit and more particularly to an engine unit including an engine and an exhaust gas recirculation device.

### 2. Description of Related Art

An engine unit including an internal combustion engine, an exhaust gas recirculation (EGR) passage that allows an intake passage and an exhaust passage of the internal combustion engine to communicate with each other, and an EGR valve that is provided in the EGR passage has been proposed (for example, see Japanese Unexamined Patent Application Publication No. 2017-133372 (JP 2017-133372 A)). In such an engine unit, when it is determined that foreign matter is caught between a valve member and a valve seat of the EGR valve, a foreign matter removal control of repeatedly performing an operation of opening and closing the EGR valve a plurality of times is performed. In this way, foreign matter caught in the EGR valve is removed.

### SUMMARY

In such an engine unit, since a foreign matter removal control is performed while the internal combustion engine is being rotationally driven, there is a likelihood that a rotation speed of the internal combustion engine will change with a change in an amount of exhaust gas flowing in the EGR passage due to the operation of opening and closing the EGR valve and a driver will feel an uncomfortable feeling such as an accelerating feeling or a decelerating feeling. In this case, when an amount of intake air of the internal combustion engine is increased to prevent an engine stall, the likelihood that a driver will feel such an uncomfortable feeling increases.

The disclosure provides an engine unit that can prevent an uncomfortable feeling from being given to a driver.

An engine unit according to the disclosure employs the following means.

According to an aspect of the disclosure, there is provided an engine unit including, an engine, an exhaust gas recirculation device including a communication pipe by which an exhaust pipe and an intake pipe of the engine to communicating and a valve that is provided in the communication pipe, and a control device. The control device is configured to perform a foreign matter removal control that is opening and closing the valve when catching of foreign matter in the valve is detected and the engine stops.

According to this aspect, when catching of foreign matter in the valve is detected and the rotation of the engine substantially stops, a foreign matter removal control of opening and closing the valve is performed. Accordingly, when the foreign matter removal control is performed to remove foreign matter, a change in rotation speed of the engine is less likely to occur and thus it is possible to prevent an uncomfortable feeling from being given to a driver.

In the aspect, the valve may be configured to vibrate at the time of being opened and closed.

In the aspect, the valve may be configured to be driven by a stepping motor.

According to these configurations, when the foreign matter removal control is performed, it is possible to more reliably remove foreign matter.

In the aspect, the control device may be configured to perform the foreign matter removal control when it is instructed to stop a system and a rotation speed of the engine has become equal to or less than a predetermined rotation speed.

In the aspect, the control device may be configured to perform the foreign matter removal control when it is instructed to stop the system and the engine has stopped.

In the aspect, the engine unit may further include a pressure sensor configured to detect a pressure in the intake pipe as a detected intake air pressure. The control device may be configured to estimate the pressure in the intake pipe as an estimated intake air pressure and to determine whether foreign matter is caught in the valve through comparison of an intake air pressure difference between the detected intake air pressure and the estimated intake air pressure with a threshold value.

In the aspect, the control device may be configured to perform the foreign matter removal control that is opening and closing the valve when the catching of foreign matter in the valve is detected and a rotation speed of the engine is zero.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an engine unit which is mounted in a vehicle 10 according to an embodiment of the disclosure;

FIG. 2 is a flowchart illustrating an example of a process routine which is performed by an electronic control unit 70; and

FIG. 3 is a diagram illustrating an example in which foreign matter removal control is performed.

### DETAILED DESCRIPTION OF EMBODIMENTS

Hereinafter, an embodiment of the disclosure will be described with reference to the accompanying drawings.

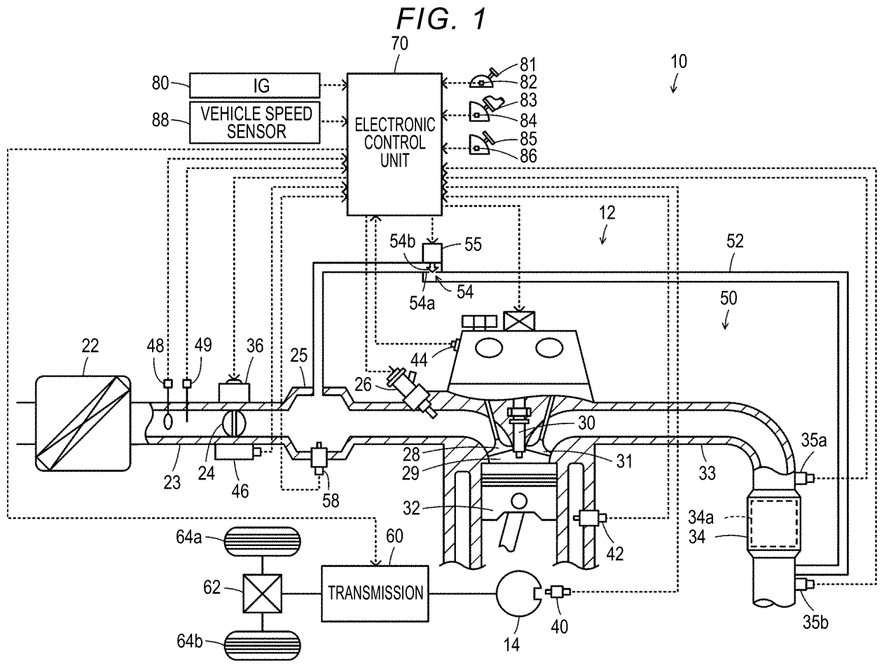

FIG. 1 is a diagram schematically illustrating a configuration of an engine unit which is mounted in a vehicle 10 according to an embodiment of the disclosure. As illustrated in the drawing, the engine unit which is mounted in the vehicle 10 according to an embodiment includes an engine 12, an exhaust gas recirculation device (hereinafter referred to as an “EGR device”) 50, a transmission 60 that is connected to a crankshaft 14 of the engine 12 and connected to driving wheels 64a and 64b via a differential gear 62, and an electronic control unit 70 that comprehensively controls the vehicle.

The engine 12 is configured as an internal combustion engine that outputs power using fuel such as gasoline or diesel. In the engine 12, air which has been cleaned by an air cleaner 22 is sucked into an intake pipe 23 and flows sequentially through a throttle valve 24 and a surge tank 25, fuel is injected from a fuel injection valve 26 downstream from the surge tank 25 in the intake pipe 23, and the air and the fuel are mixed. Then, this air-fuel mixture is sucked into a combustion chamber 29 via an intake valve 28 and is exploded and combusted using sparks of an ignition plug 30. Then, a translational motion of a piston 32 which is pressed by energy based on the explosion and combustion is converted to a rotational motion of the crankshaft 14. Exhaust gas which is discharged from the combustion chamber 29 to an exhaust pipe 33 via an exhaust valve 31 is discharged to outside air via an exhaust gas control device 34 including a catalyst (a three-way catalyst) 34a that removes harmful components such as carbon monoxide (CO), hydrocarbons (HC), or nitrogen oxide (NOx) and is supplied (recirculated) to the intake pipe 23 via the EGR device 50.

The EGR device 50 includes an EGR pipe 52 and an EGR valve 54. The EGR pipe 52 causes a downstream portion of the exhaust pipe 33 with respect to the exhaust gas control device 34 and the surge tank 25 of the intake pipe 23 to communicate with each other. The EGR valve 54 is provided in the EGR pipe 52 and includes a valve seat 54a and a valve member 54b. The valve seat 54a includes a hole with a diameter smaller than the inner diameter of the EGR pipe 52. The valve member 54b is driven by a stepping motor 55 and moves in an axial direction of the valve member 54b (a vertical direction in the drawing). The EGR valve 54 is closed by allowing the valve member 54b to move toward the valve seat 54a (downward in the drawing) such that a tip (a lower end in the drawing) of the valve member 54b closes the hole of the valve seat 54a. The EGR valve 54 is opened by allowing the valve member 54b to move away from the valve seat 54a (upward in the drawing) such that the tip of the valve member 54b is separated from the valve seat 54a to open the hole of the valve seat 54a. The EGR device 50 adjusts an amount of exhaust gas recirculated in the exhaust pipe 33 and returns the exhaust gas to the intake pipe 23 by adjusting the opening of the EGR valve 54 using the stepping motor 55. The engine 12 can suck a mixture of air, exhaust gas, and fuel into the combustion chamber 29 in this way. In the following description, this recirculation of exhaust gas is referred to as “EGR” and an amount of recirculated exhaust gas is referred to as an “EGR volume.”

The electronic control unit 70 is configured as a microprocessor including a CPU as a main component, and includes a ROM that stores a processing program, a RAM that temporarily stores data, and input and output ports in addition to the CPU. Signals from various sensors which are required for controlling the operation of the engine 12 are input to the electronic control unit 70 via the input port.

Examples of the signals which are input to the electronic control unit 70 include a crank angle θcr from a crank position sensor 40 that detects a rotational position of the crankshaft 14 of the engine 12 and a coolant temperature Tw from a coolant temperature sensor 42 that detects a temperature of a coolant of the engine 12. Examples of the signals also include cam angles θci and θco from a cam position sensor 44 that detects a rotational position of an intake cam shaft opening and closing the intake valve 28 and a rotational position of an exhaust cam shaft opening and closing the exhaust valve 31. Examples of the signals also include a throttle opening TH from a throttle position sensor 46 that detects a position of a throttle valve 24, an amount of intake air Qa from an air flowmeter 48 attached to the intake pipe 23, an intake air temperature Ta from a temperature sensor 49 attached to the intake pipe 23, and a detected intake air pressure Pind which is a detected value of a pressure in the surge tank 25 and which is supplied from a pressure sensor 57 attached to the surge tank 25. Examples of the signals also include an air-fuel ratio AF from an air-fuel ratio sensor 35a attached to the exhaust pipe 33 and an oxygen signal 02 from an oxygen sensor 35b attached to the exhaust pipe 33. Examples of the signals also include an ignition signal IG from an ignition switch 80 and a shift position SP from a shift position sensor 82 that detects an operation position of a shift lever 81. Examples of the signals also include an accelerator operation amount Acc from an accelerator pedal position sensor 84 that detects an amount of depression of an accelerator pedal 83, a brake pedal position BP from a brake pedal position sensor 86 that detects an amount of depression of a brake pedal 85, and a vehicle speed V from a vehicle speed sensor 88.

Various control signals for controlling the operation of the engine 12 are output from the electronic control unit 70 via the output port. Examples of the control signals which are output from the electronic control unit 70 include a control signal for a throttle motor 36 that adjusts the position of the throttle valve 24, a control signal for the fuel injection valve 26, a control signal for the ignition plug 30, and a control signal for the stepping motor 55 that adjusts the opening of the EGR valve 54. Examples of the control signals also include a control signal for a transmission 60.

The electronic control unit 70 calculates a rotation speed Ne of the engine 12 based on the crank angle θcr from the crank position sensor 40. The electronic control unit 70 also calculates an estimated intake air pressure Pine which is an estimated value of the pressure in the surge tank 25 based on the amount of intake air Qa from the air flowmeter 48. Here, the estimated intake air pressure Pine can be calculated, for example, by applying the amount of intake air Qa to a relationship which is determined in advance by experiment or analysis between the amount of intake air Qa and the estimated intake air pressure Pine.

In the engine unit which is mounted in the vehicle 10 according to this embodiment having the above-mentioned configuration, the electronic control unit 70 sets a target gear stage Gs* of the transmission 60 based on the accelerator operation amount Acc or the vehicle speed V and controls the transmission 60 such that a gear stage Gs of the transmission 60 reaches the target gear stage Gs*. The electronic control unit 70 sets a target torque Te* of the engine 12 based on the accelerator operation amount Acc, the vehicle speed V, or the gear stage Gs of the transmission 60 and performs operation control of the engine 12 (for example, control of the amount of intake air, fuel injection control, or ignition control) or control of the EGR device 50 such that the engine 12 operates based on the target torque Te*.

In controlling the EGR device 50, when an EGR condition is satisfied, a target EGR volume Vegr* is set based on an operating point (the target torque Te* and the rotation speed Ne) of the engine 12 or the like, a target opening Ov* of the EGR valve 54 is set based on the target EGR volume Vegr*, and the stepping motor 55 is controlled based on the target opening Ov* of the EGR valve 54. On the other hand, when the EGR condition is not satisfied, the target opening Ov* of the EGR valve 54 is set to 0, and the stepping motor 55 is controlled based on the target opening Ov* of the EGR valve 54. As the EGR condition, a condition that warming-up of the engine 12 is completed, a condition that the target torque Te* of the engine 12 is in an EGR execution area, or the like is used.

In the engine unit which is mounted in the vehicle 10 according to the embodiment, when a diagnosis condition is satisfied, the electronic control unit 70 performs catching diagnosis which is diagnosing whether foreign matter is caught between the valve seat 54a and the valve member 54b of the EGR valve 54 by comparison of an intake air pressure difference ΔPin (=|Pind−Pine|) which is a difference between the detected intake air pressure Pind and the estimated intake air pressure Pine with a threshold value ΔPinref. In this catching diagnosis, when it is determined that foreign matter is caught in the EGR valve 54, a foreign matter catching flag Ff is set to 1. When it is determined that foreign matter is not caught in the EGR valve 54, the foreign matter catching flag Ff is set to 0. As the diagnosis condition, for example, a condition that the EGR condition is not satisfied (the target opening Ov* of the EGR valve 54 has a value of 0) is used.

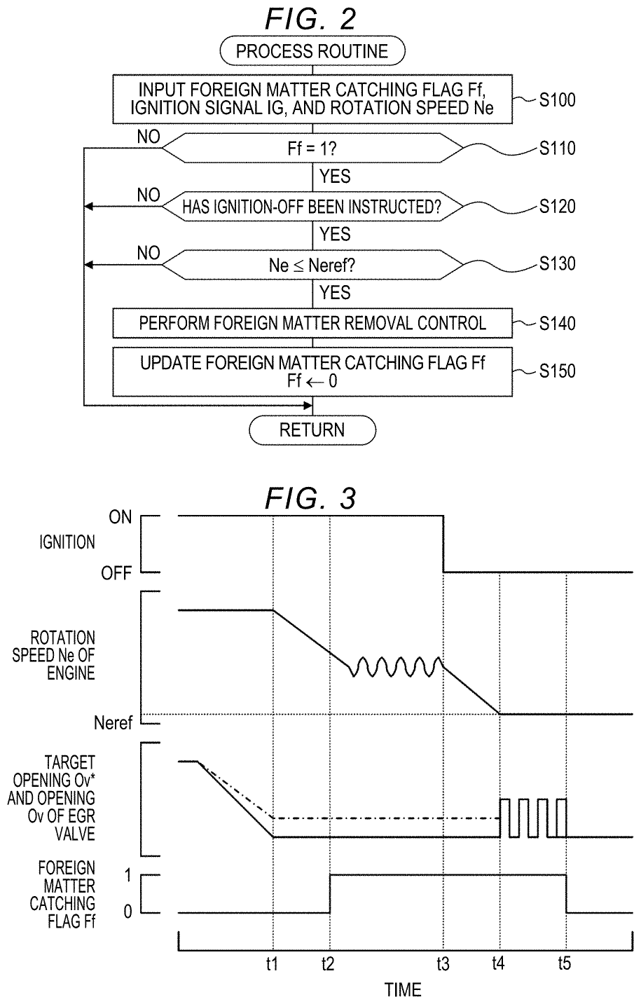

The operation of the engine unit which is mounted in the vehicle 10 according to the embodiment having the above-mentioned configuration, particularly, the operation when foreign matter is caught in the EGR valve 54, will be described below. FIG. 2 is a flowchart illustrating an example of a process routine which is performed by the electronic control unit 70. This routine is repeatedly performed.

When the process routine illustrated in FIG. 2 is performed, the electronic control unit 70 first inputs data such as the foreign matter catching flag Ff, the ignition signal IG, and the rotation speed Ne of the engine 12 (Step S100). Here, the value which has been set as described above is input as the foreign matter catching flag Ff. A signal from the ignition switch 80 is input as the ignition signal IG. A value which is calculated based on the crank angle θcr from the crank position sensor 40 is input as the rotation speed Ne of the engine 12.

When data is input in this way, the value of the foreign matter catching flag Ff is checked (Step S110). When the value of the foreign matter catching flag Ff is 0, it is determined that foreign matter is not caught in the EGR valve 54 and this process routine ends without performing foreign matter removal control which will be described later.

When the value of the foreign matter catching flag Ff is 1 in Step S110, it is determined that foreign matter is caught in the EGR valve 54, it is determined whether ignition-off (stopping a system) has been instructed based on the ignition signal IG (Step S120), and the rotation speed Ne of the engine 12 is compared with a threshold value Neref (Step S130). When the ignition signal IG indicates OFF, the electronic control unit 70 determines that ignition-off has been instructed and stops the operation of the engine 12 (such as fuel injection control or ignition control). Accordingly, the rotation speed Ne of the engine 12 decreases to 0. The threshold value Neref is a threshold value which is used to determine whether the engine 12 substantially stops its rotation, and for example, a value of 0 or a value which is slightly greater than 0 is used. When ignition-off has not been instructed or when the rotation speed Ne of the engine 12 is greater than the threshold value Neref, this process routine ends without performing foreign matter removal control.

When it is determined in Step S120 that ignition-off has been instructed and it is determined in Step S130 that the rotation speed Ne of the engine 12 is equal to or less than the threshold value Neref, foreign matter removal control is performed (Step S140), the foreign matter catching flag Ff is updated to 0 (Step S150), and this process routine ends. Here, in foreign matter removal control, the target opening Ov* is set such that the EGR valve 54 is repeatedly opened and closed (the opening of the EGR valve 54 is repeatedly increased and decreased), and the stepping motor 55 is controlled based on the set target opening Ov*. Since the EGR valve 54 is driven by the stepping motor 55, the EGR valve 54 vibrates finely at the time of being opened and closed. Accordingly, by allowing the EGR valve 54 to vibrate finely at the time of being opened and closed, it is possible to remove foreign matter which is caught between the valve seat 54a and the valve member 54b of the EGR valve 54. When the EGR valve 54 is opened and closed during rotational driving of the engine 12, there is a likelihood that the rotation speed Ne of the engine 12 will change with a change in an amount of exhaust gas flowing in the EGR pipe 52 due to the operation of opening and closing the EGR valve 54 and a driver will feel an uncomfortable feeling such as an accelerating feeling or a decelerating feeling. At this time, when the throttle opening TH is increased to increase the amount of intake air Qa in order to prevent an engine stall, the likelihood that a driver will feel an uncomfortable feeling is increased. On the other hand, in the embodiment, foreign matter removal control is performed when the rotation of the engine 12 substantially stops. Accordingly, when foreign matter removal control is performed to remove foreign matter, change of the rotation speed Ne of the engine 12 is less likely to occur and thus it is possible to prevent an uncomfortable feeling from being given to a driver.

FIG. 3 is a diagram illustrating an example in which foreign matter removal control is performed. As illustrated in the drawing, when it is determined that foreign matter is caught in the EGR valve 54 (at time t1), the value of the foreign matter catching flag Ff is switched from 0 to 1 (at time t2). When ignition-off is instructed (at time t3), the operation of the engine 12 stops. When the rotation speed Ne of the engine 12 is equal to or less than the threshold value Neref (at time t4), foreign matter removal control is performed. Accordingly, it is possible to prevent an uncomfortable feeling from being given to a driver and to remove foreign matter. Then, when foreign matter removal control ends (at time t5), the value of the foreign matter catching flag Ff is switched from 1 to 0. Thereafter, the opening Ov and the target opening Ov* of the EGR valve 54 substantially match each other.

In the engine unit according to the embodiment described above, when it is determined that foreign matter is caught in the EGR valve 54 and the engine 12 stops, foreign matter removal control is performed. Accordingly, when foreign matter removal control is performed, change of the rotation speed Ne of the engine 12 is less likely to occur and thus it is possible to prevent an uncomfortable feeling from being given to a driver. Since the EGR valve 54 vibrates finely at the time of being opened and closed, it is possible to more reliably remove foreign matter.

In the engine unit which is mounted in the vehicle 10 according to the embodiment, when ignition-off has been instructed and the rotation of the engine 12 substantially stops, foreign matter removal control is performed. However, even when ignition-on is maintained, foreign matter removal control may be performed on the premise that the engine 12 stops. An example of the case in which the engine 12 stops at the time of ignition-on is a case in which the engine 12 stops automatically due to satisfaction of an automatic stopping condition (an idling stopping condition) in a vehicle in which idling stopping control can be performed.

In the engine unit which is mounted in the vehicle 10 according to the embodiment, the EGR valve 54 is driven by the stepping motor 55 and vibrates finely at the time of being opened and closed. However, the EGR valve 54 may be driven by another motor or the like. Even when the EGR valve 54 does not vibrate finely at the time of being opened and closed, it is thought that foreign matter can be removed to a certain extent by repeated opening and closing of the EGR valve 54.

The engine unit according to the embodiment is described as being mounted in a vehicle 10 which travels with an output of the engine 12, but it may be mounted in a hybrid vehicle including a traveling motor in addition to the engine or may be mounted in equipment which does not move such as construction equipment.

Correspondence between principal elements in the embodiment and principal elements of the disclosure in the SUMMARY will be described below. In the embodiment, the engine 12 is an example of an “engine,” the EGR device 50 is an example of an “exhaust gas recirculation device,” the EGR pipe 52 is an example of a “communication pipe,” and the electronic control unit 70 is an example of a “control device.”

The correspondence between the principal elements in the embodiment and the principal elements in the SUMMARY does not limit the elements of the disclosure in the SUMMARY, because the embodiment is an example for specifically describing the aspect in the SUMMARY. That is, it should be noted that the disclosure in the SUMMARY should be construed based on the description therein and the embodiment is only a specific example of the disclosure in the SUMMARY.

While an embodiment of the disclosure has been described above, the disclosure is not limited to the embodiment and can be modified in various forms without departing from the gist of the disclosure.

The disclosure is applicable to the manufacturing industry of engine units.

What is claimed is:

1. An engine unit comprising:
an engine;
an exhaust gas recirculation device including a communication pipe by which an exhaust pipe of the engine and an intake pipe of the engine to communicating, and a valve that is provided in the communication pipe; and
a control device,
wherein the control device is configured to perform a foreign matter removal control that is opening and closing the valve when catching of foreign matter in the valve is detected and the engine stops.

2. The engine unit according to claim 1, wherein the valve is configured to vibrate at a time of being opened and closed.

3. The engine unit according to claim 2, wherein the valve is driven by a stepping motor.

4. The engine unit according to claim 1, wherein the control device is configured to perform the foreign matter removal control when it is instructed to stop a system and a rotation speed of the engine has become equal to or less than a predetermined rotation speed.

5. The engine unit according to claim 4, wherein the control device is configured to perform the foreign matter removal control when it is instructed to stop the system and the engine has stopped.

6. The engine unit according to claim 1, further comprising a pressure sensor configured to detect a pressure in the intake pipe as a detected intake air pressure,
wherein the control device is configured to estimate the pressure in the intake pipe as an estimated intake air pressure and to determine whether foreign matter is caught in the valve through comparison of an intake air pressure difference between the detected intake air pressure and the estimated intake air pressure with a threshold value.

7. The engine unit according to claim 1, wherein the control device is configured to perform the foreign matter removal control that is opening and closing the valve when the catching of foreign matter in the valve is detected and a rotation speed of the engine is zero.
